(19) United States
(12) Patent Application Publication
(10) Pub. No.: US 2016/0176164 A1
(43) Pub. Date: Jun. 23, 2016

(54) LAMINATED BODY

(71) Applicant: HITACHI METALS, LTD., Tokyo (JP)

(72) Inventors: Kei TAKAHASHI, Tokyo (JP); Mika Hayashi, Tokyo (JP)

(21) Appl. No.: 14/967,076

(22) Filed: Dec. 11, 2015

(30) Foreign Application Priority Data
Dec. 19, 2014 (JP) 2014-257668

(51) Int. Cl. B32B 25/04; B32B 5/18; B32B 7/02; B32B 25/02

(52) U.S. Cl. CPC B32B 25/04; B32B 25/02; B32B 25/042; B32B 5/18; B32B 7/02; B32B 2264/108; B32B 2305/026

(57) ABSTRACT

There is provided a new technique of making easy to use a rubber member formed by using a rubber composition containing rubber and porous carbon material particles produced from plant material, wherein a laminated body includes a supporting member; and a porous carbon material particle-containing rubber layer formed by a rubber composition containing rubber and porous carbon material particles produced from plant material, and further includes an intermediate rubber layer between the supporting member and the porous carbon material particle-containing rubber layer; wherein the supporting member is vulcanization-adhered to the intermediate rubber layer, and the intermediate rubber layer is vulcanization-adhered to the porous carbon material particle-containing rubber layer, to thereby vulcanization-adhere the porous carbon material particle-containing rubber layer on the supporting member.

### BACKGROUND

1. Technical Field

The present invention relates to a laminated body having a rubber layer.

2. Description of Related Art

There is proposed a technique of obtaining a rubber composition excellent in low friction and wear resistance, by adding porous carbon material particles (such as RB ceramics particles) produced from plant material (see patent document 1).

Patent document 1: Japanese Patent Laid Open Publication No. 2014-15577

### SUMMARY OF THE INVENTION

An object of the present invention is to provide a new technique of making it easy to use a rubber member formed using a rubber composition containing rubber and porous carbon material particles produced from plant material.

According to an aspect of the present invention, there is provided a laminated body including:

a supporting member;

a porous carbon material particle-containing rubber layer which is vulcanization-adhered on the supporting member and made of a rubber composition containing rubber and porous carbon material particles produced from plant material; and further

an intermediate rubber layer made of a rubber material, between the supporting member and the porous carbon material particle-containing rubber layer,

wherein the supporting member is vulcanization-adhered to the intermediate rubber layer, and the intermediate rubber layer is vulcanization-adhered to the porous carbon material particle-containing rubber layer, to thereby vulcanization-adhere the porous carbon material particle-containing rubber layer on the supporting member.

According to a vulcanization-adhesion structure through the intermediate rubber layer, the porous carbon material particle-containing rubber layer is firmly adhered to the supporting member, so as to be supported by the supporting member in a fixed shape. Therefore, the porous carbon material partible-containing rubber layer is easily used as a rubber member of various applications.

### BRIEF DESCRIPTION OF THE DRAWINGS

FIG. 1 is a cross-sectional view showing a schematic structure of a laminated body according to an embodiment of the present invention.

### DETAILED DESCRIPTION OF THE INVENTION

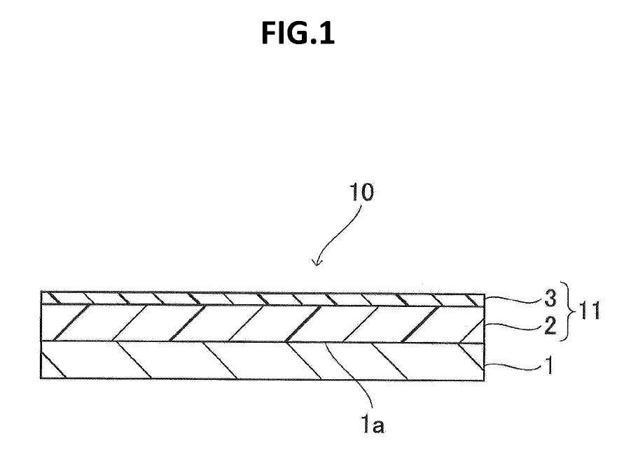

A laminated body according to an embodiment of the present invention will be described, with reference to FIG. 1. FIG. 1 is a cross-sectional view showing a schematic structure of a laminated body 10 according to an embodiment.

An entire structure of the laminated body 10 will be described first. The laminated body 10 is constituted including a supporting member 1, an intermediate rubber layer 2 which is vulcanization-adhered on the supporting member 1, and a porous carbon material particle-containing rubber layer 3 which is vulcanization-adhered on the intermediate rubber layer 2. A laminated part of the intermediate rubber layer 2 and the porous carbon material particle-containing rubber layer 3, is called a rubber member 11 in some cases. The laminated body 10 is also called a structure in which the rubber member 11 is laminated on the supporting member 1.

The surface of the laminated body 10 is constituted by an upper surface of the rubber member 11, namely, an upper surface of the porous carbon material particle-containing rubber layer 3 disposed on the supporting member 1 through the intermediate rubber layer 2. As described later in detail, the porous carbon material particle-containing rubber layer 3 is made of a rubber composition in which porous carbon material particles produced from plant material is added to rubber, and therefore has a property excellent in low friction and wear resistance. The laminated body 10 exhibits the property excellent in low friction and wear resistance, by having the porous carbon material particle-containing rubber layer 3 in a surface portion, and can be widely used as a member requiring the low friction and wear resistance, such as a bearing member of a rotation device, or a material for constituting a holding member, etc., for holding a vibrating member in contact with this member, for example.

If a structure is formed only by the rubber composition constituting the porous carbon material particle-containing rubber layer 3, a fixed (constant, specific) shape is hardly maintained, thus making it difficult to use such a structure. The supporting member 1 is used as a support made of a material having a higher rigidity (hardness) than the rubber composition constituting the porous carbon material particle-containing rubber layer 3, so that the porous carbon material particle-containing rubber layer 3 can be used in a fixed (constant, specific) shape. That is, the supporting member 1 is made of a member having a fixed shape (member maintaining the fixed shape by itself).

The shape of the supporting member 1 can be suitably selected according to the purpose of use of the laminated body 10. Namely, the shape of the supporting member 1 can be suitably selected, so that the porous carbon material particle-containing rubber layer 3 (rubber member 11) has a desired shape according to the purpose of use. For example, FIG. 1 shows a flat supporting member 1 having a flat surface on which the rubber member 11 is disposed. However, it is also acceptable to use the supporting member 1 as needed, having a curved surface on which the rubber member 11 is disposed.

Inventors of the present invention consider regarding the use of the vulcanization-adhesion, thereby obtaining a strong adhesion, as a method of adhering the porous carbon material particle-containing rubber layer 3 on the supporting member 1 which is the support. However, as described later, the porous carbon material particle-containing rubber layer 3 is made of the rubber composition in which a plurality of porous carbon material particles (for example, 160 parts by mass or more based on 100 parts by mass of rubber) is added to rubber. Therefore, it would be a problem if the vulcanization-adhesion is not satisfactorily carried out like a case of adhering a usual rubber member on the supporting member (metal plate, etc.), when the porous carbon material particle-containing rubber layer 3 is directly vulcanization-adhered on the supporting member 1.

Therefore, the inventors of the present invention attempt to obtain the vulcanization-adhesion structure in which the porous carbon material particle-containing rubber layer 3 is vulcanization-adhered on the supporting member 1 by interposing the intermediate rubber layer 2. As a result, it is found that the porous carbon material particle-containing rubber layer 3 can be satisfactorily vulcanization-adhered on the supporting member 1.

More specifically, it is possible to obtain the laminated body 10 in which the porous carbon material particle-containing rubber layer 3 is vulcanization-adhered on the supporting member 1, by allowing the intermediate rubber layer 2 made of the rubber material, to vulcanization-adhered on the supporting member 1 via a vulcanization-adhesive agent 1a, and allowing the porous carbon material particle-containing rubber layer 3 to vulcanization-adhered on the intermediate rubber layer 2.

That is, the laminated body 10 of this embodiment is the structure including the supporting member 1 and the porous carbon material particle-containing rubber layer 3 which is vulcanization-adhered on the supporting member 1, and further including the intermediate rubber layer 2 made of a rubber material between the supporting member 1 and the porous carbon material particle-containing rubber layer 3, wherein the supporting member 1 is vulcanization-adhered to the intermediate rubber layer 2, and the intermediate rubber layer 2 is vulcanization-adhered to the porous carbon material particle-containing rubber layer 3, to thereby allow the porous carbon material particle-containing rubber layer 3 to vulcanization-adhered on the supporting member 1.

The material of the intermediate rubber layer 2 will be described later in detail. The material of the supporting member 1 is not particularly limited, as long as it is the material having a higher rigidity than the rubber composition constituting the porous carbon material particle-containing rubber layer 3 as described above, and the material capable of vulcanization-adhering the intermediate rubber layer 2 by the vulcanization-adhesive agent 1a, and can be suitably selected according to the purpose of use of the laminated body 10. As the material of the supporting member 1, specifically for example, metal, ceramics, and resins (such as nylon, curing phenol, epoxy, polycarbonate, PTFE (polytetrafluoroethylene), etc.) or the like, can be given.

FIG. 1 shows, for example, a structure in which the rubber member (intermediate rubber layer 2 and porous carbon material particle-containing rubber layer 3) is disposed on one of the surfaces of the plate-like supporting member 1. However, for example, it is also acceptable to form a structure in which the rubber member 11 (intermediate rubber layer 2 and porous carbon material particle-containing rubber layer 3) is disposed on both surfaces of the plate-like supporting member 1.

Materials, etc., of the porous carbon material particle-containing rubber layer 3 and the intermediate rubber layer 2 will be described next.

The porous carbon material particle-containing rubber layer 3 is made of a rubber composition containing rubber and porous carbon material particles produced from plant material. The rubber contained in the rubber composition constituting the porous carbon material particle-containing rubber layer 3 is not particularly limited, and can be used if it can be vulcanization-adhered, and can be suitably selected according to the purpose of use of the laminated body 10. Specifically speaking, Natural rubber, isoprene rubber, ethylene-propylene-diene rubber, ethylene propylene rubber, chlorinated polyethylene rubber, butadiene rubber, chloroprene rubber, chlorosulfonated polyethylene rubber, styrene-butadiene, isobutylene-isoprene rubber, acrylonitrile-butadiene rubber, acrylic rubber, silicone rubber, fluorine rubber, urethane rubber, and epichlorohydrin rubber, etc., can be given. It is also acceptable to use by blending them. More specifically, for example ethylene-propylene-diene rubber (EPDM) can be preferably used as the rubber for the porous carbon material particle-containing rubber layer 3, which has excellent weather resistance and heat resistance, etc.

For example RB (Rice Bran) ceramics particles can be given as the porous carbon material particles produced from plant material (simply called “porous carbon material particles in some cases), which are contained in the rubber composition constituting the porous carbon material particle-containing rubber layer 3. RB ceramics is composed of a defatted bran carbide (soft amorphous carbon) and a glassy carbon (hard amorphous carbon) which is a carbide of a phenol resin, and is a hard porous carbon material having several pores.

A content of the porous carbon material particles in the rubber composition constituting the porous carbon material particle-containing rubber layer 3, is preferably set to an amount so that a friction coefficient of the rubber composition in the atmosphere or in the water, is lower than a friction coefficient of the rubber alone contained in the rubber composition in the atmosphere or in the water. By containing the porous carbon material particles, a high wear resistance of the rubber composition can also be obtained.

It is found by the inventors of the present invention that by adding to the rubber (such as EPDM) for example about 160 parts by mass or more of the porous carbon material particles (such as RB ceramics particles) based on 100 parts by mass of the rubber, the friction coefficient in the atmosphere or in the water can be decreased, and by adding for example about 200 parts by mass or more of the porous carbon material particles, the friction coefficient can be more decreased. It is also found that according to such an addition amount of the porous carbon material particles, a high wear resistance of the rubber composition can be obtained. Accordingly, more specifically, the content of the porous carbon material particles in the rubber composition constituting the porous carbon material particle-containing rubber layer 3, is, for example, preferably set to 160 parts by mass or more and more preferably 200 parts by mass or more based on 100 parts by mass of the rubber contained in the rubber composition.

An upper limit of the content of the porous carbon material particles in the rubber composition constituting the porous carbon material particle-containing rubber layer 3, is not particularly limited. However, the porous carbon material particle-containing rubber layer 3 is possibly easily broken, due to a reduction of a rubber elasticity of the rubber composition, which is caused by addition of a large volume of porous carbon material particles. It is found by the inventors of the present invention that when a rubber member is formed by the rubber composition in which for example about 340 parts by mass or more of the porous carbon material particles (such as RB ceramics particles) are added, based on 100 parts by mass of the rubber, the breakage of the rubber member during use is likely to occur. Accordingly, more specifically, the content of the porous carbon material particles in the rubber composition constituting the porous carbon material particle-containing rubber layer 3, is preferably set to for example 340 parts by mass or less based on 100 parts by mass of the rubber contained in the rubber composition.

An average particle size of each porous carbon material particle is not particularly limited. For example, the particle size is preferably set within a range of 2 μm or more and 53 μm or less, from a viewpoint of uniformly dispersing the porous carbon material particles in the rubber composition.

In addition to the abovementioned rubber and the porous carbon material particles, a vulcanizing agent (crosslinking agent), a vulcanization aid (cross-linked aid), a filler, a flame retardant, a plasticizer, an antiaging agent (antioxidant), a stabilizer, a coloring agent, or a processing aid etc., may also be contained in the rubber composition constituting the porous carbon material particles-containing rubber layer 3.

The intermediate rubber layer 2 is made of a rubber material (material containing rubber). The rubber contained in the rubber material constituting the intermediate rubber layer 2, is not particularly limited to be used if the vulcanization adhesion can be performed, and can be suitably selected according to the purpose of use of the laminated body 10. Specifically speaking, a similar one as the rubber for example contained in the rubber composition constituting the porous carbon material particles-containing rubber layer 3, can be used. More specifically, for example ethylene-propylene-diene rubber (EPDM) can be preferably used, which has excellent weather resistance and heat resistance, etc.

The rubber contained in the rubber composition constituting the porous carbon material particles-containing rubber layer 3, and the rubber contained in the rubber material constituting the intermediate rubber layer 2, are not required to be made of the same kind of material. However, from a viewpoint of strengthening the vulcanization adhesion between the porous carbon material particles-containing rubber layer 3 and the intermediate rubber layer 2, the vulcanization rates of these rubbers are preferably equivalent to each other, and for example these rubbers are preferably made of the same kind of materials or the same vulcanization-type materials. The same vulcanization-type material refers to the material that can be vulcanized under the same vulcanization condition.

The rubber material constituting the intermediate rubber layer 2 may suitably contain a vulcanizing agent (crosslinking agent), a vulcanization aid (cross-linking aid), a filler, a flame retardant, a plasticizer, an antiaging agent (antioxidant), a stabilizer, a coloring agent, or a processing aid etc., in addition to the abovementioned rubber.

The porous carbon material particles are not required to be contained in the rubber material constituting the intermediate rubber layer 2. The rubber material constituting the intermediate rubber layer 2 is considered to be the material with less content of the porous carbon material particles in the rubber, compared to the rubber composition constituting the porous carbon material particles-containing rubber layer 3, from a viewpoint of comparing to the rubber composition constituting the porous carbon material particles-containing rubber layer 3.

As the addition amount of the porous carbon material particles into the rubber becomes more increased, the rubber elasticity of the rubber composition becomes low, and the rigidity of the rubber composition becomes high (the rubber composition becomes hard). Therefore, in the porous carbon material particles-containing rubber layer 3, although the low friction or the wear resistance is more increased compared to the intermediate rubber layer 2, the rubber elasticity becomes low and the rigidity becomes high.

Preferably, the porous carbon material particles-containing rubber layer 3, that is, a surface portion of the rubber member 11, has excellent low friction or wear resistance, and although it is not particularly a problem that the rubber elasticity is reduced with addition of the porous carbon material particles, the rubber member 11 as an entire body preferably has a certain degree or more of the rubber elasticity (cushion property) in some cases.

In the laminated body 10 of this embodiment, by forming the rubber member 11 in a lamination structure of the intermediate rubber layer 2 and the porous carbon material particles-containing rubber layer 3, namely, by forming the rubber member 11 in a structure having the intermediate rubber layer 2 with a higher rubber elasticity than the porous carbon material particles-containing rubber layer 3, the rubber elasticity of the rubber member 11 can be high, compared to a case if the rubber member 11 is made of only the porous carbon material particles-containing rubber layer 3. Thus, the intermediate rubber layer 2 has not only a function of vulcanization-adhering the porous carbon material particles-containing rubber layer 3 on the supporting member 1 so as to be interposed between the porous carbon material particles-containing rubber layer 3 and the supporting member 1, but also a function of increasing the rubber elasticity of the rubber member 11.

In order to increase the rubber elasticity of the rubber member 11 as the entire body, for example, it is preferable to increase the thickness of the intermediate rubber layer 2, for example to increase the thickness of the intermediate rubber layer 2 more than the thickness of the porous carbon material particles-containing rubber layer 3. When there is an unevenness on the intermediate rubber layer 2 or the porous carbon material particles-containing rubber layer 3 and the thickness is not constant, and when this case is taken into consideration, for example, it is conceivable to set an average thickness of the intermediate rubber layer 2 to be larger than an average thickness of the porous carbon material particles-containing rubber layer 3, or for example set the average thickness of the intermediate rubber layer 2 to be larger than the thickness of a thickest portion of the porous carbon material particles-containing rubber layer 3.

By forming the rubber member 11 in the lamination structure of the intermediate rubber layer 2 and the porous carbon material particles-containing rubber layer 3, the addition amount of the porous carbon material particles is decreased, compared to a case of forming the structure in which the porous carbon material particles are added over the entire thickness of the rubber member 11. Therefore, there is an advantage that a fabrication cost of the rubber member 11 and the laminated body 10 can be reduced.

A method of manufacturing the laminated body 10 of this embodiment will be described next exemplarily. A metal plate having a thickness of 3 mm made of stainless steel such as SUS304, etc., is prepared as the supporting member 1. An unvulcanized rubber layer having a specific thickness (for example, 3 mm) made of EPDM for example, is prepared as the intermediate rubber layer 2.

As the porous carbon material particle-containing rubber layer 3, for example, an unvulcanized rubber layer is prepared, having a specific thickness (for example, 1 mm) and formed by adding RB ceramics to EPDM which is the same kind of material as the intermediate rubber layer 2. The content of the RB ceramics is 249.63 parts by mass for example, based on 100 parts by mass of EPDM.

A blast treatment such as sand blasting is applied to a surface of the supporting member 1 on which the intermediate rubber layer 2 is adhered. Thereafter, the vulcanization-adhesive agent 1a is applied on the surface of the blasted supporting member 1. As the vulcanization-adhesive agent 1a, for example, Chemlok (Chemlok is a registered trademark) by LORD Corporation, can be used. As the vulcanization-adhesive agent 1a, one kind may be used or two kinds or more may be used in combination.

The unvulcanized intermediate rubber layer 2 is disposed on the surface of the supporting member 1 on which the vulcanization-adhesive agent 1a is applied, and the unvulcanized porous carbon material particle-containing rubber layer 3 is disposed on the unvulcanized intermediate rubber layer 2, to thereby form an unvulcanized laminated body. Then, such a laminated body is interposed between heat plates, and pressed at a high temperature and high pressure (for example, at about 151° C., and about 3.63 MPa), to thereby perform vulcanization of the intermediate rubber layer 2 and the porous carbon material particle-containing rubber layer 3, and simultaneously perform vulcanization-adhesion of the supporting member 1 and the intermediate rubber layer 2, and vulcanization-adhesion of the intermediate rubber layer 2 and the porous carbon material particle-containing rubber layer 3. Thus, the laminated body 10 of this embodiment is fabricated.

For example, when 90 degree peel test was performed to the laminated body 10 fabricated by the abovementioned method for example, a strong adhesive strength of causing a rubber breakdown to occur, could be obtained.

As described above, according to the present invention, the laminated body can be obtained, in which the porous carbon material particle-containing rubber layer excellent in low friction, etc., is laminated on the supporting member.

According to the vulcanization-adhesion structure through the intermediate rubber layer, the porous carbon material particle-containing rubber layer is firmly adhered on the supporting member and can be supported by the supporting member in a fixed shape. Therefore, the porous carbon material particle-containing rubber layer can be used as a rubber member of each kind of application.

According to the rubber member having a lamination structure of the intermediate rubber layer and the porous carbon material particle-containing rubber layer, rubber elasticity as an entire body of the rubber member can be increased compared to a case that the rubber member is constituted only by the porous carbon material particle-containing rubber layer, and a cost reduction can be realized.

As described above, the present invention has been described based on the embodiments. However, the present invention is not limited thereto, and for example, it is obvious for a skilled person that various modifications, improvements, and combinations, etc., are possible.

Preferable aspects of the present invention will be described supplementarily hereafter.

### (Supplementary Description 1)

According to an aspect of the present invention, there is provided a laminated body, including:

a supporting member;

a porous carbon material particle-containing rubber layer which is vulcanization-adhered on the supporting member and made of a rubber composition containing rubber and porous carbon material particles produced from plant material; and further

an intermediate rubber layer made of a rubber material, between the supporting member and the porous carbon material particle-containing rubber layer,

wherein the supporting member is vulcanization-adhered to the intermediate rubber layer, and the intermediate rubber layer is vulcanization-adhered to the porous carbon material particle-containing rubber layer, to thereby vulcanization-adhere the porous carbon material particle-containing rubber layer on the supporting member.

### (Supplementary Description 2)

There is provided the laminated body of the supplementary description 1, wherein a content of the porous carbon material particles in the rubber composition, is 160 parts by mass or more based on 100 parts by mass of the rubber contained in the rubber composition.

### (Supplementary Description 3)

There is provided the laminated body of the supplementary description 1 or 2, wherein the content of the porous carbon material particles in the rubber composition, is 340 parts by mass or less based on 100 parts by mass of the rubber contained in the rubber composition.

### (Supplementary Description 4)

There is provided the laminated body of any one of the supplementary descriptions 1 to 3, wherein the porous carbon material particles are RB ceramics particles.

### (Supplementary Description 5)

The laminated body of any one of the supplementary descriptions 1 to 4, wherein the supporting member is made of a material having a higher rigidity than the rubber composition constituting the porous carbon material particle-containing rubber layer.

### (Supplementary Description 6)

There is provided the laminated body of any one of the supplementary descriptions 1 to 5, wherein the supporting member is constituted as a member having a fixed shape.

### (Supplementary Description 7)

There is provided the laminated body of any one of the supplementary descriptions 1 to 6, wherein a thickness of the intermediate rubber layer is larger than a thickness of the porous carbon material particle-containing rubber layer.

### (Supplementary Description 8)

There is provided the laminated body of any one of the supplementary descriptions 1 to 7, wherein an average thickness of the intermediate rubber layer is larger than an average thickness of the porous carbon material particle-containing rubber layer.

### (Supplementary Description 9)

There is provided the laminated body of any one of the supplementary descriptions 1 to 8, wherein the average thickness of the intermediate rubber layer is larger than a largest thickness of the porous carbon material particle-containing rubber layer.

### (Supplementary Description 10)

There is provided the laminated body of any one of the supplementary descriptions 1 to 9, wherein the rubber contained in the rubber composition is ethylene-propylene-diene rubber.

### (Supplementary Description 11)

There is provided the laminated body of any one of the supplementary descriptions 1 to 10, wherein the rubber contained in the rubber material is ethylene-propylene-diene rubber.

### (Supplementary Description 12)

There is provided the laminated body of any one of the supplementary descriptions 1 to 11, wherein the rubber contained in the rubber composition, and rubber contained in the rubber material are same kind of materials.

### (Supplementary Description 13)

There is provided the laminated body of any one of the supplementary descriptions 1 to 11, wherein the rubber contained in the rubber composition, and rubber contained in the rubber material, are same vulcanization-type materials.

### (Supplementary Description 14)

According to other aspect of the present invention, there is provided a laminated body, including:

a supporting member;

an intermediate rubber layer which is vulcanization-adhered on the supporting member and made of a rubber material; and

a porous carbon material particle-containing rubber layer which is vulcanization-adhered on the intermediate rubber layer, and formed by a rubber composition containing rubber and porous carbon material particles produced from plant material.

### (Supplementary Description 15)

According to further other aspect of the present invention, there is provided a rubber member, including:

a first rubber layer made of a rubber material; and

a second rubber layer which is vulcanization-adhered on the first rubber layer and formed by a rubber composition containing rubber and porous carbon material particles produced from plant material,

wherein a thickness of the first rubber layer is larger than a thickness of the second rubber layer.

What is claimed is:

1. A laminated body, comprising:
a supporting member;
a porous carbon material particle-containing rubber layer which is vulcanization-adhered on the supporting member and made of a rubber composition containing rubber and porous carbon material particles produced from plant material; and further
an intermediate rubber layer made of a rubber material, between the supporting member and the porous carbon material particle-containing rubber layer,
wherein the supporting member is vulcanization-adhered to the intermediate rubber layer, and the intermediate rubber layer is vulcanization-adhered to the porous carbon material particle-containing rubber layer, to thereby vulcanization-adhere the porous carbon material particle-containing rubber layer on the supporting member.

2. The laminated body according to claim 1, wherein a content of the porous carbon material particles in the rubber composition, is 160 parts by mass or more based on 100 parts by mass of the rubber contained in the rubber composition.

3. The laminated body according to claim 1, wherein the supporting member is made of a material having a higher rigidity than the rubber composition constituting the porous carbon material particle-containing rubber layer.

4. The laminated body according to claim 1, wherein a thickness of the intermediate rubber layer is larger than a thickness of the porous carbon material particle-containing rubber layer.

5. The laminated body according to claim 1, wherein the rubber contained in the rubber composition, and rubber contained in the rubber material are same kind of materials.

6. The laminated body according to claim 1, wherein the rubber contained in the rubber composition, and rubber contained in the rubber material, are the materials that can be vulcanized under the same vulcanization condition.
